(19) United States
(12) Patent Application Publication
(10) Pub. No.: US 2020/0218232 A1
(43) Pub. Date: Jul. 9, 2020

(54) SYSTEM AND METHOD FOR FLUID FLOW CONTROL DESIGN

(71) Applicant: General Electric Company, Schenectady, NY (US)

(72) Inventors: James Albert TALLMAN, Glenville, NY (US); Nicholas RATHAY, Rock City Falls, NY (US); Corey BOURASSA, Mechanicville, NY (US)

(21) Appl. No.: 16/238,664

(22) Filed: Jan. 3, 2019

(51) Int. Cl. G05B 19/416; G05B 19/042

(52) U.S. Cl. CPC G05B 19/416; G05B 2219/37371; G05B 2219/2619; G05B 19/042

(57) ABSTRACT

According to some embodiments, an operating environment measurement of an industrial asset may be received from at least one sensor. A high-fidelity physics-based model may represent operational performance of the industrial asset and the performance's dependency on the operating environment measurement. A surrogate model creation engine may automatically create a surrogate model of the industrial asset based on the operating environment measurement and results from the high-fidelity physics-based model. An optimization platform may receive the surrogate model and use the surrogate model along with an optimization algorithm to generate a set of optimized fluid flow control system parameters for the industrial asset. In this way, a fluid flow control system may be designed to improve the performance of the industrial asset.

### BACKGROUND

The performance of an industrial asset might be impacted by surrounding fluid flow characteristics. For example, the efficiency of a wind turbine might be altered by the ways in which air travels near the turbine's blades. It is known that fluid flow control components (including passive and active components) may be provided to direct fluid flow and thereby improve performance of the industrial asset. Note that these fluid flow control components might comprise a number of different devices and that the location or placement of the devices may impact the ability to control fluid flow (and thus performance of the industrial asset). Typically, an expert will manually use a trial-and-error approach to determine exactly how to physically locate and/or orient these fluid flow control components on the industrial asset so as to best improve performance (e.g., using wind tunnels and turbine blade models or complex physics-based computer simulations).

Such an approach can be a time-consuming and expensive process. It would therefore be desirable to design a fluid flow control system in an automatic and accurate manner.

### SUMMARY

According to some embodiments, an operating environment measurement of an industrial asset may be received from at least one sensor. A high-fidelity physics-based model may represent operation performance of the industrial asset and the performance's dependency on the operating environment measurement. A surrogate model creation engine may automatically create a surrogate model of the industrial asset based on the operating environment measurement and results from the high-fidelity physics-based model. An optimization platform may receive the surrogate model and use the surrogate model along with an optimization algorithm to generate a set of optimized fluid flow control system parameters for the industrial asset. In this way, a fluid flow control system may be designed to improve the performance of the industrial asset.

Some embodiments comprise: means for receiving, from at least one sensor, an operating environment measurement of an industrial asset; means for receiving results of a high-fidelity physics-based model that represents operational performance of the industrial asset and the performance's dependency on the operating environment measurement; means for automatically creating, by a surrogate model creation engine, a surrogate model of the industrial asset based on the operating environment measurement and the results; means for receiving, at an optimization platform, the surrogate model; and means for using the surrogate model along with an optimization algorithm to generate a set of optimized fluid flow control system parameters for the industrial asset.

Some technical advantages of some embodiments disclosed herein are improved systems and methods to design a fluid flow control system in an automatic and accurate manner. Moreover, embodiments may let an optimized design be achieved in a relatively short amount of time (e.g., a design might be constantly updated and optimized as sensor data is received by the system).

### BRIEF DESCRIPTION OF THE DRAWINGS

FIG. 1 is a high-level block diagram of a wind turbine according to some embodiments.

FIG. 2 is a high-level block diagram of an autonomous fluid flow control system design optimization architecture that may in accordance with some embodiments.

FIG. 3 is a fluid flow control system optimization method according to some embodiments.

FIG. 4 is a fluid flow control system deployment process in accordance with some embodiments.

FIG. 5 illustrates a fluid flow control deployment according to some embodiments.

FIG. 6 is a high-level block diagram of a fluid flow control system design optimization architecture for an industrial asset in accordance with some embodiments.

FIG. 7 is a fluid flow control system design optimization display in accordance with some embodiments.

FIG. 8 is a fluid flow control system design optimization apparatus according to some embodiments.

FIG. 9 is portion of a tabular repository database in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

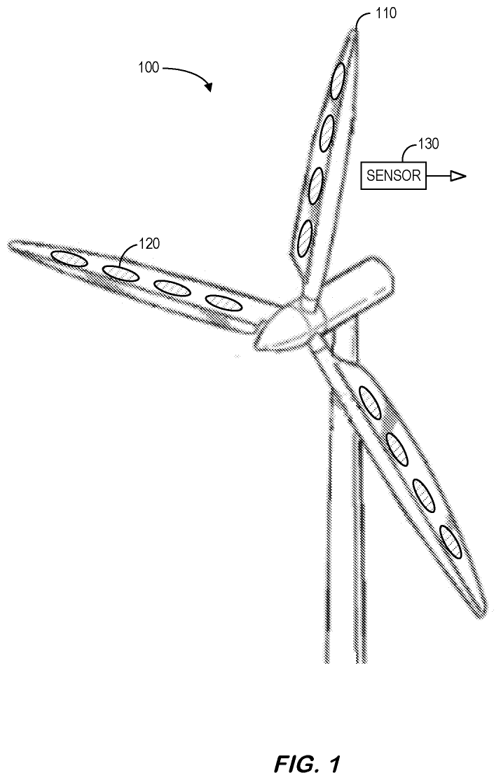

FIG. 1 is a high-level block diagram of a wind turbine 100 according to some embodiments. The wind turbine 100 includes three turbine blades 110 and the performance of the turbine may be based at least in part on the way that air moves across those blades 110. According to some embodiments, an array of fluid flow control components 120 may be provided on the blades 110. As used herein, the term “array” might refer to any arrangement of fluid flow control components 120 (e.g., including a single row or line of components). Although four individual components 120 are illustrated on each turbine blade 110 in FIG. 1, any number of such components 120 might be provided instead (including a single component 120 on each blade 110). The precise number utilized might depend on the type of actuators used, the type of blade the actuators are used with, the placement of the actuators, and any other applicable design considerations.

The fluid flow control components 120 might include passive flow control devices (e.g., small metal foils that are attached to the blades 110 at particular locations and/or orientations). According to some embodiments, the fluid flow control components 120 are associated with an active flow control actuator array (e.g., that are able to move during operation of the wind turbine 100 to dynamically alter the flow of air across the blades 110).

By way of example, active flow control actuators might be linearly aligned proximate to and parallel with a trailing edge of the turbine blade 110. Such a position may allow for the interaction of actuating air from the active flow control actuators with the ambient airflow over the leading edge of the blade 110 to alter a pressure differential and improve performance of the wind turbine 100.

The active flow control actuators may be any type of flow control actuators, including but not limited to synthetic jets, sweep jets, flaperons, active vortex generators, plasma actuators, combustion-based actuators, and/or any combination thereof. For example, piezoelectric disks may be utilized as active flow control actuators to control the fluid flow over the blades 110. It should be clear that the shape and configuration of the active flow control actuators shown in the figures is not intended to be limiting. It should be appreciated that active flow control actuators may be activated electronically or pneumatically, or according to any desired method depending on the type of actuators used.

One or more sensors 130 located proximate to the wind turbine 100 may measure and transmit various physical environmental characteristics (e.g., an operating environment measurement or operational performance measurement). For example, the sensor 130 might measure air temperature, wind speed, blade 110 rotation characteristics, etc. which may, according to some embodiments, be used to help optimize the design of the fluid flow control components 120 (e.g., the location, spacing, orientation, operating parameters, etc. of the components 120). Note that as used herein, the term “sensor” might include a priori knowledge about an industrial asset and/or its location (e.g., including knowledge that exists before the industrial asset is created that can be used to estimate or approximate sensor data as compared to an actual “live” sensor data).

Traditional approaches to optimize a flow control system require complex and/or expensive testing or design simulations to arrive at a viable commercial product. Typically, the product is something general in design that might be applied to many similar industrial assets, meaning that might be sub-optimal for a particular asset's operating environment.

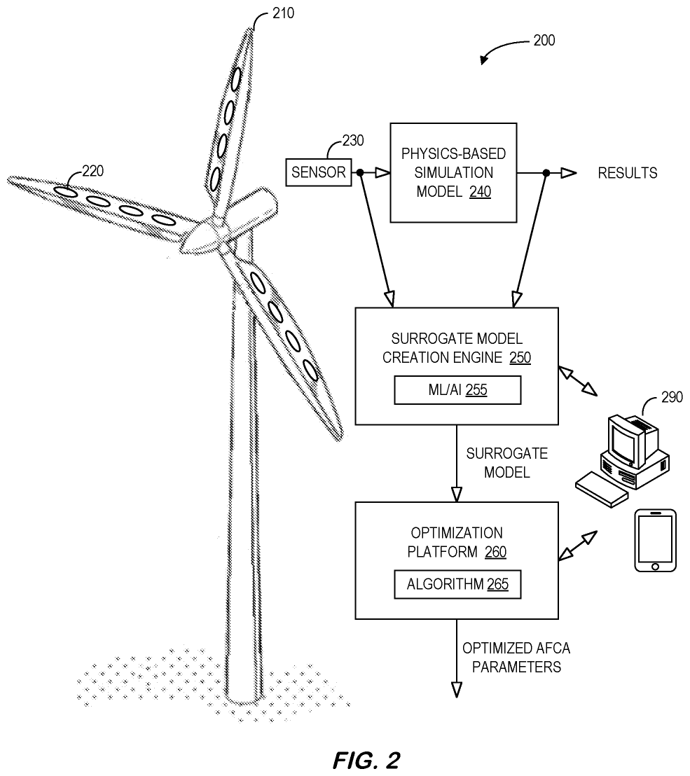

To avoid such a situation, FIG. 2 is a high-level block diagram of an autonomous fluid flow control system design optimization architecture 200 that may in accordance with some embodiments. In particular, the system 200 includes a wind turbine blades 210 having arrays of fluid flow control components 220. One or more sensors 230 provide operating measurements to a physic-based simulation model 240 that generates results (representing operational performance of the industrial asset and the performance's dependency on an operating environment measurement). According to some embodiments, at least one sensor 230 may provide an operational performance measurement of the industrial asset. A surrogate model creation engine 250 monitors the operating measurements and the result from the physics-based simulation model 240 and uses Machine Learning (“ML”) and/or Artificial Intelligence (“AI”) to create a surrogate model that is transmitted to an optimization platform 260. According to some embodiments, the surrogate model creation engine 250 and/or optimization platform 260 are associated with an enterprise that executes a user interface at a remote user device 290. The surrogate model creation engine 250 may store information into and/or retrieve information from various data stores or sources in connection with the user interface and/or other components. The surrogate model creation engine 250 may exchange information with the remote user device 290 via a communication port and/or firewall. Based on the operating measurements from the sensor 230 (e.g., input “X” values), the surrogate model creation engine 250 may execute the physics-based simulation model 240 to create a response surface result or output (e.g., “Y” values). The high-fidelity physics-based model might be associated with, for example, Finite Element Method (“FEM”) and/or Finite Element Analysis (“FEA”) techniques. The response surface may be used by a machine learning process “off-line” to create a trained surrogate model for the substantially real-time optimization platform 250. As used herein, the phrase “machine learning” might refer to, for example, techniques associated with polynomial response surfaces, kriging, Gradient-Enhanced Kriging (“GEK”), radial basis function, support vector machines, space mapping, and artificial neural networks, etc. According to some embodiments, multiple techniques may be applied in parallel and the system 200 may recommend which is approach is most appropriate for or is best suited to accurately reproduce a particular physics-based simulation model's response surface. According to some embodiments (e.g., early in the design process when there are not many installed units and/or sensors), sensor data might be artificially generated. For example, a physics-based model might be executed to create a response surface, create a surrogate model, etc.

The surrogate model creation engine 250 and/or the other elements of the system 200 might be, for example, associated with a Personal Computer (“PC”), laptop computer, smartphone, an enterprise server, a server farm, cloud services, and/or a database or similar storage devices. According to some embodiments, an “automated” surrogate model creation engine 250 (and/or other elements of the system 200) may facilitate the creation of surrogate models. As used herein, the term “automated” may refer to, for example, actions that can be performed with little (or no) intervention by a human.

As used herein, devices, including those associated with the surrogate model creation engine 250, and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Although a single surrogate model creation engine 250 is shown in FIG. 2, any number of such devices may be included. Moreover, various devices described herein might be combined according to embodiments of the present invention. For example, in some embodiments, the surrogate model creation engine 250 and the optimization platform 260 might be co-located, cloud-based, and/or may comprise a single apparatus.

The optimization platform 260 uses the surrogate model and an optimization algorithm 265 to generate optimized Active Flow Control Actuator (“AFCA”) parameters. The AFCA parameters might, for example, define how the fluid flow control components 220 should be arranged on the turbine blades 210. Thus, the system 200 may autonomously create a design that improves operation of the industrial asset (i.e., the wind turbine).

As used herein, the phrase “surrogate model” may refer to a simulation model that results when machine learning algorithms are applied to training data that was generated by a traditional “physics-based simulation model” 240. As used herein, the phrase “physics-based simulation model” 240 might refer to, for example, a model where first principal equations (and subsequent derivations based on them) are applied to solve an engineering problem of relevance. The physics-based simulation model 240 might be as simple as a spreadsheet calculator or as complex as a massively parallel computational fluid dynamics problem. Note that the phrase “physics-based simulation model” 240 might refer to any physics-based model or tool chain workflow. For example, a workflow might comprise geometry generation, followed by mesh generation, followed by pre-processing, followed by a physics-based solution, followed by post-processing, followed by a figure-of-merit output (that is, the workflow may represent more than simply a Computational Fluid Dynamics (“CFD”) solution). In general, a model workflow might be associated with: a component level model, a module level model, a system level module, data that varies in space, data that varies in time, input parameters, post-processing, etc.

A primary advantage of the surrogate model is in its speed. While the physics-based simulation model 240 can take a substantially long period of time to execute (e.g., days, weeks, or months depending on the complexity of the problem being solved), the surrogate model may execute nearly instantaneously (e.g., seconds or minutes) regardless of the complexity of the underlying physics-based simulation model 240 that it reproduces. With surrogate modeling, the full fidelity physics-based simulation model 240 can be deployed for the optimization platform 260 that might require “real time” model throughputs to generate the AFCA parameters.

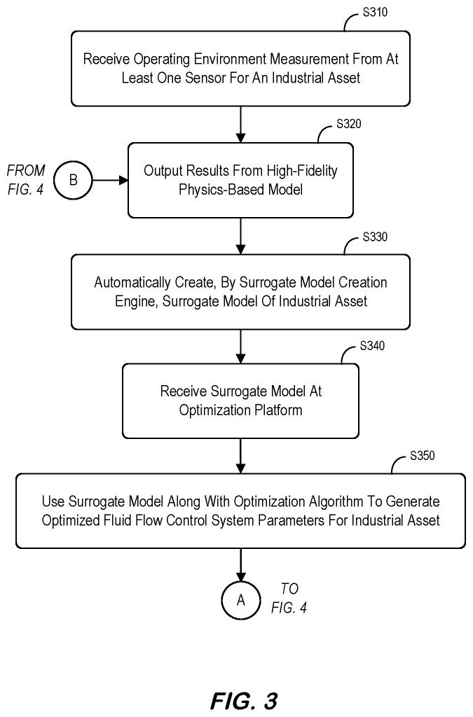

FIG. 3 is a fluid flow control system optimization method that might be performed by some or all of the elements of the system 200 described with respect to FIG. 2. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, an operating environment measurement may be received from at least one sensor associated with an industrial asset. When the industrial asset is a wind turbine, for example, the operating parameter measurements might be associated with: wind speed, wind direction, wind turbulence, temperature, a proximity to other wind turbines, ground topology data, etc. In this way, an individual wind turbine unit's operational environment (range) may be measured in the field under various conditions. According to some embodiments, the operating environment measurements may help define under what conditions the high-fidelity physics-based model should be executed (e.g., one could take wind speed measurements and determine that a physics-based model should be conducted for speeds from 5 meters-per-second (“m/s”) to 15 m/s).

At S320, the system may output results from a high-fidelity physics-based model that represents operational performance of the industrial asset and the performance's dependency on the operating environment measurement. The physics-based simulation model (e.g., CFD) may include the effect of AFCAs that is exercised on that wind turbine over the range of the unit's operating environment. The model may include the effects of position of the AFCAs and/or the operational settings of the AFCAs.

At S330, a surrogate model creation engine may automatically create a surrogate model of the industrial asset based on the operating environment measurement and the results from the high-fidelity physics-based model. The surrogate model creation engine might create the surrogate model using, for example, a machine learning process, an artificial intelligence process, a data regression process, and/or a closed-loop control process. In this way, a surrogate model may be developed that reproduces the response of the physics-based simulation model and does so in substantially real-time (rather than waiting for the physics-based simulation to execute). In some embodiments, the surrogate model may be developed using machine learning and/or artificial intelligence.

An optimization platform may receive the surrogate model at S340, and the system may use the surrogate model along with an optimization algorithm to generate a set of optimized fluid flow control system parameters for the industrial asset at S350. Note that the fluid flow control system might be associated with, for example: a subsonic flow environment, a supersonic flow environment, a hypersonic flow environment, a gaseous flow environment, a liquid flow environment, a two-phase flow environment, etc. Moreover, the fluid flow control system might utilze passive flow control components and/or an active flow control actuator array. The optimized fluid flow control system parameters might be associated with, for example: physical locations of components of the fluid flow control system, an orientation of components of the fluid flow control system, an operational setting of at least one active fluid flow control component (e.g., a frequency), etc. Note that the optimized fluid flow control system parameters might be associated with an operational behavior of the fluid flow control components. For example, the parameters might be used to design individual actuators in a desired, optimized way or to select appropriate actuators that are already available. Moreover, the optimized fluid flow control system parameters might be associated with a design type of a fluid flow control component (e.g., several different existing or pre-created designs might be available in a catalog or library and the parameters could be used to help select the most appropriate design in view of an operating range of an industrial asset).

In this way, the surrogate model may be used by an optimization algorithm or routine to determine the optimum placement and/or operational point of each of the plurality of AFCAs. This optimum might be associated with multiple objectives and specific to that particular turbine's operating environment. The optimum operational point of each of the individual AFCAs may be dependent on the real-time operating conditions of the wind turbine and may be adjusted and/or modulated by a controller that leverages the surrogate model. According to some embodiments, flow actuators might be movably located on a slider mechanism such that the actuators can be moved after the entity is deployed in the field (without needing to retrofit the industrial asset). Similarly, a dense array of flow actuators might be provided such that individual actuators can be turned on (or off) as indicated the by optimization algorithm while the industrial asset it deployed in situ. Note that the execution of the high-fidelity physics-based model and/or the surrogate model creation engine might be associated with a high-performance computing center and/or a cloud-based computing environment.

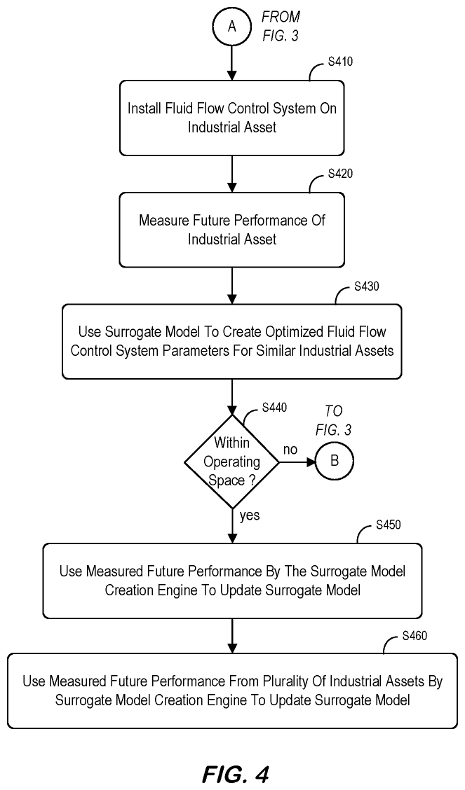

FIG. 4 is a fluid flow control system deployment process in accordance with some embodiments. At S410, the fluid flow control system may be created based on the optimized fluid flow control system parameters (S350) and installed on the industrial asset. For example, an optimized flow AFCA system might be created and installed on the particular wind turbine unit.

At S420, the system may measure future performance of industrial asset. This information might be stored, for example, in a repository data store. According to some embodiments, sensors may be added to a wind turbine unit to monitor and record its performance with the AFCA system installed. The recorded performance may be analogous in data structure to the output of either the physics-based simulation model or the surrogate model. According to some embodiments, the sensors may accumulate a data stream for that particular unit (which absorbs the operating conditions and the performance output and places that information into a database).

At S430, the system may us the surrogate model to create optimized fluid flow control system parameters for similar industrial assets (e.g., other wind turbines). If the similar asset is not within the operating space of the existing surrogate mode at S440, the process might return S320 to gather more information. That is, S410 and S420 may be repeated for subsequent wind turbine units within their specific turbine operational environment. In the event that an individual turbine's operational environment does not fall within the range of the surrogate model's intended operation, S320 might be revisited and updated.

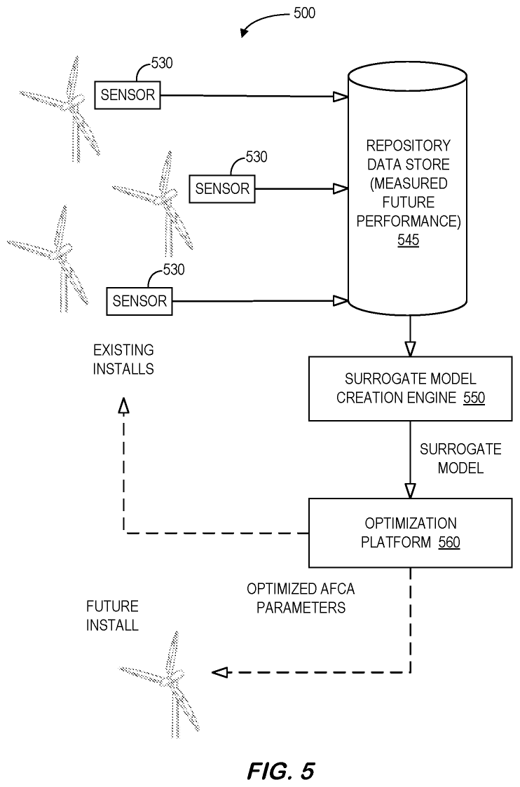

At S450, the system may use the measured future performance (e.g., as an input to the surrogate model creation engine) to update the surrogate model. According to some embodiments, measured future performance from a plurality of industrial assets is used by the surrogate model creation engine to update the surrogate model at S460. For example, FIG. 5 illustrates a fluid flow control deployment 500 according to some embodiments. Sensors 530 associated with multiple existing wind turbines installed in the field (each having a recommended fluid flow control system) is stored into a repository datastore 545. A surrogate model creation engine 550 may use this data to create a surrogate model for an optimization platform 560. In this way, optimized AFCA parameters may be improved and deployed in future installs (as well as being used to update existing installs). Note that sensor data from multiple units and/or physics-based models could be fed into a single surrogate model representation or multiple, separate surrogate model representations. For example, a fleet operator might want a surrogate specifically associated with their fleet of turbines (and separate from those associated with competitor units). In other cases, a fleet of surrogate models, each representing a single unit within a fleet, might be deployed and an optimizer might either optimize a specific unit (using only that unit's surrogate) or all of the surrogates in the fleet as a whole.

That is, for all turbines that have been retrofitted with turbine-specific optimized AFCA systems, the data from the sensor 530 data streams are used to develop further enhancements and/or improvements of the surrogate model. In some embodiments, the surrogate model is based on machine learning, and the data streams represent new “observations” for the machine learning algorithms. In some embodiments, the data streams are absorbed directly by the machine learning algorithms and the surrogate model is dynamically updated in continuum. This evolving surrogate model may be used for subsequent activities of S340, S350, S4410, S420, etc., which subsequently creates more data for the surrogate model to consume and use to evolve. Over time (e.g., after five years of deployment), the surrogate model may become more and more accurate at reproducing the performance of the turbine units, and thus, the optimization associated may become better and better. In some embodiments, the originally retrofitted turbines from the early stages of the surrogate model may be revisited and re-optimized (e.g., by adjusting fluid flow control positions and/or operations) at a later date because the surrogate model may have evolved and/or improved in accuracy (and the optimization point might also be different).

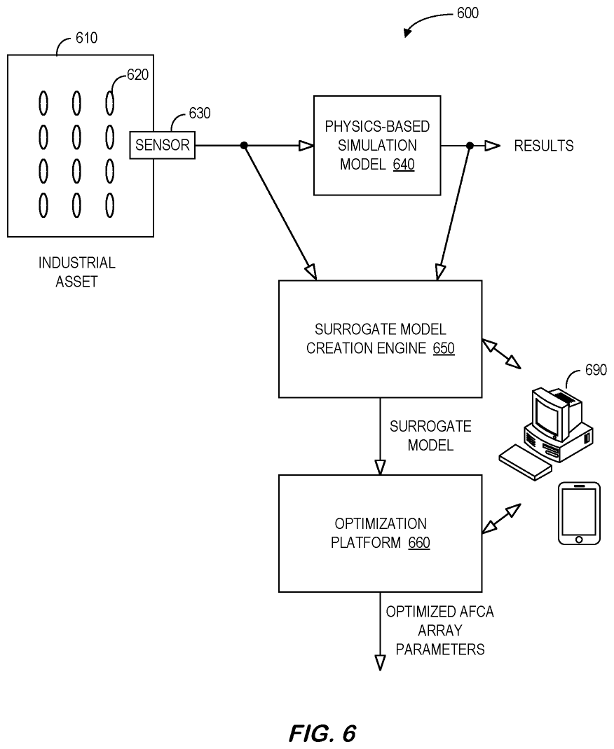

Although wind turbines are used herein as an example, note that embodiments may be associated with any type of industrial asset. For example, FIG. 6 is a high-level block diagram of a fluid flow control system design optimization architecture 600 for an industrial asset in accordance with some embodiments. As before, the performance of an industrial may be based at least in part on the way that fluid moves across or through the industrial asset 610. According to some embodiments, an array of fluid flow control components 620 may be provided on the industrial asset 610. The fluid flow control components 620 might include passive flow control devices and/or an active flow control actuator array

One or more sensors 630 located proximate to the industrial asset 610 may measure and transmit various physical environmental characteristics (e.g. an operating environment measurement or operational performance measurement) to a physic-based simulation model 640 that generates results representing operational performance of the industrial asset and the performance's dependency on the operating environment measurement. A surrogate model creation engine 650 monitors the operating measurements and results from the physics-based simulation model 640 and creates a surrogate model that is transmitted to an optimization platform 660. According to some embodiments, the surrogate model creation engine 650 and/or optimization platform 660 may be accessed via a remote user device 690. The optimization platform 660 uses the surrogate model to generate optimized AFCA array parameters. The AFCA array parameters might, for example, define how the fluid flow control components 620 should be arranged on the industrial asset 610. Thus, the system 600 may autonomously create a design that improves operation of the industrial asset 610.

According to some embodiments, the surrogate model creation engine 650 may create an initial population of simulation points associated with surrogate model training. This population of simulation points may be associated with a Design Of Experiments (“DOE”) process (even when referring to simulation “experiments” and not necessarily true physical experiments). In particular, two DOEs may execute during each loop of the system training: a training DOE and a validation DOE. The two DOEs may have distinctly different specific operating points (but still encompass the same ranges of the input parameters (i.e., X's)). Note that the X's and the range of their operations may have previously been provided.

Both DOEs may be executed expediently using high-performance computing systems (e.g., either locally adjacent or via a cloud/web computing service). As such, the system may become a consumer of high-performance computing resources. The resultant response surfaces from both DOEs may be stored in a locally-available database (where they can then be accessed for machine learning and surrogate model training). The training DOE response surface may be subsequently consumed by machine learning training calculations—which can also be performed by consuming either local or cloud/web high-performance computing resources. The trained surrogate model may then be applied on the validation DOE solution inputs, and the surrogate model outputs (Y's) may be compared against the validation DOE outputs (Y's) to assess the accuracy of the surrogate model. If the accuracy is acceptable, the surrogate model is ready for use and may be output to the optimization platform 660. If the accuracy is not acceptable, additional DOE points may be defined based on areas of inaccuracy (both for training and validation), and the process may repeat. In various embodiments, the validation DOE results from one pass through the process may be recycled for training DOE data in subsequent passes.

Thus, embodiments may involve devices operating within an aero/hydro/fluid flow environment (including hypersonic environments), which can be retrofitted with AFCA components to improve the performance of the device's operation within that environment (e.g., a wind turbine airfoil). Embodiments may provide a process by which unit-specific AFCA arrays can be designed and optimized quickly, to offer a customized commercial package toward improving the device's performance (versus a single-design, one-size-fits-all product). Finally, embodiments may leverage the speed and adaptability of surrogate modeling, along with the consumption of data streams from the fielded units, to drive improved accuracy of the surrogate models and, subsequently, a better unit-specific optimum design.

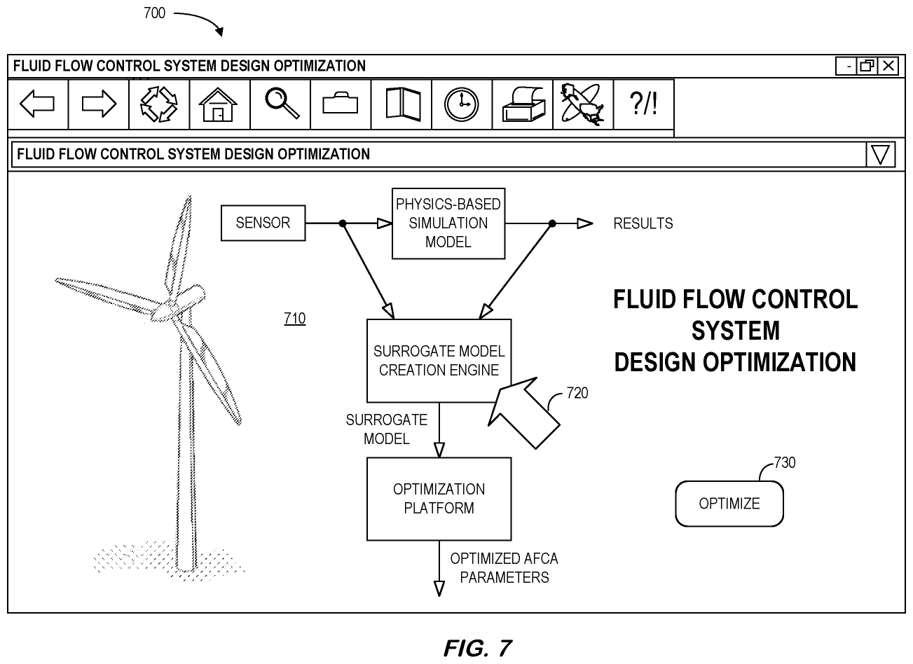

According to some embodiments, a graphical user interface may let an operator interact with the fluid flow control system design framework. For example, FIG. 7 is a fluid flow control system design optimization display 700 in accordance with some embodiments. The display 700 provides a graphical depiction 710 of elements of the fluid flow control system design optimization framework to an operator via an interactive interface that allows the operator to adjust system components as appropriate. For example, selection of an item on the display 700 (e.g., via a touchscreen or computer mouse pointer 720) may let the operator see more information about that particular item in a pop-up window and/or adjust operation of that item (e.g., by overriding specific parameters of a physics-based model or optimization algorithm). According to some embodiments, the display 700 further includes a user-selectable “Optimize” icon 730 that can be active to begin an optimization process.

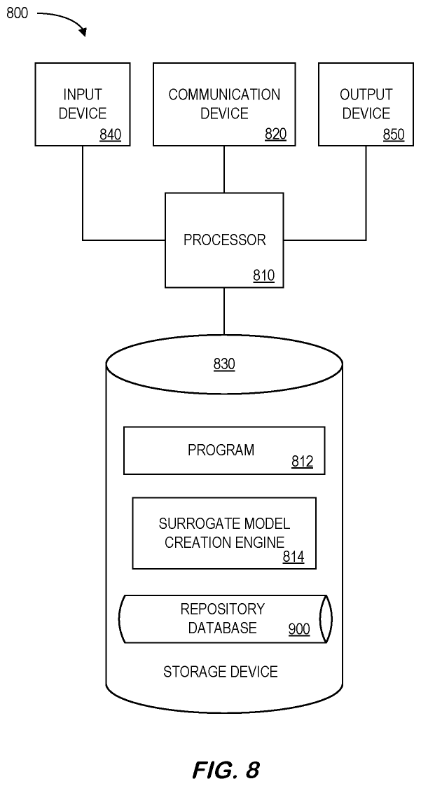

Note that the embodiments described herein may be implemented using any number of different hardware configurations. For example, FIG. 8 is a block diagram of a fluid control system design optimization apparatus 800 that may be, for example, associated with the system 200 of FIG. 2 and/or any other system described herein. The fluid flow control system design optimization apparatus 800 comprises a processor 810, such as one or more commercially available Central Processing Units (“CPUs”) in the form of one-chip microprocessors, coupled to a communication device 820 configured to communicate via a communication network (not shown in FIG. 8). The communication device 860 may be used to communicate, for example, with one or more remote surrogate model creation engines, optimization platforms, etc. The fluid flow control system design optimization apparatus 800 further includes an input device 840 (e.g., a computer mouse and/or keyboard to input optimization and/or modeling information) and/an output device 850 (e.g., a computer monitor to render a display, list available surrogate models, transmit recommendations, and/or create reports). According to some embodiments, a mobile device, a real-time analytics package, and/or a PC may be used to exchange information with the fluid flow control system design optimization apparatus 800.

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or surrogate model creation engine 814 for controlling the processor 810. The processor 810 performs instructions of the programs 812, 814, and thereby operates in accordance with any of the embodiments described herein. For example, the processor 810 may automatically create a surrogate model of an industrial asset based on an operating environment measurement and results associated with a physics-based model. The processor 810 might also use the surrogate model along with an optimization algorithm to generate a set of optimized fluid flow control system parameters for the industrial asset. In this way, a fluid flow control system may be designed to improve the performance of the industrial asset.

The programs 812, 814 may be stored in a compressed, uncompiled and/or encrypted format. The programs 812, 814 may furthermore include other program elements, such as an operating system, clipboard application, a database management system, cloud computing capabilities, and/or device drivers used by the processor 810 to interface with peripheral devices.

As used herein, information may be “received” by or “transmitted” to, for example: (i) the wind turbine protection platform 800 from another device; or (ii) a software application or module within the wind turbine protection platform 800 from another software application, module, or any other source.

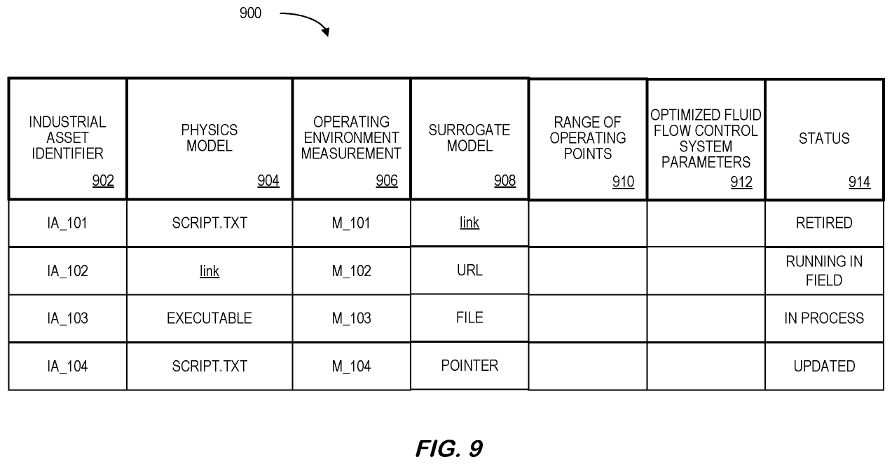

In some embodiments (such as the one shown in FIG. 8), the storage device 830 further stores a repository database 900. An example of a repository database 900 that may be used in connection with the fluid flow control system design optimization apparatus 800 will now be described in detail with respect to FIG. 9. Note that the database described herein is only one example, and additional and/or different information may be stored therein. Moreover, various databases might be split or combined (and or implemented via a cloud computing environment) in accordance with any of the embodiments described herein.

Referring to FIG. 9, a table is shown that represents the repository database 900 that may be stored at the fluid flow control system design optimization apparatus 800 according to some embodiments. The table may include, for example, entries identifying industrial assets. The table may also define fields 902, 904, 906, 908, 910, 912, 914 for each of the entries. The fields 902, 904, 906, 908, 910, 912, 914 may, according to some embodiments, specify: an industrial asset identifier 902, a physics model 904, an operating environment measurement 906, a surrogate model 908, a range of operating points 910, optimized fluid flow control system parameters 912, and a status 914. The repository database 900 may be created and updated, for example, off-line when a new physical system (e.g., industrial asset) is monitored or modeled.

The industrial asset identifier 902 may be a unique alpha-numeric code identifying and/or describing a physical system to be modeled. The physics model 904 might comprise, for example, a link to a high-fidelity physics model or executable code. The operating environment measurement 906 might reflect real-world operating values from an industrial asset deployed in the field. The surrogate model 908 might comprise, for example, a link to a model created using the results of a physics-based model and machine learning algorithms. The range of operating points 910 might comprise input parameters (X's) associated with the industrial asset. The optimized fluid flow control system parameters 912 might define how flow control components should be positioned, organized, oriented, set-up (e.g., with an oscillation frequency), etc. The status 914 might indicate that a particular set of optimized AFCA parameters is retired (e.g., no longer active because it has been superseded by an updated version), running in the field, in the process of being created, etc.

Thus, embodiments may provide an automated and accurate way to configure and design fluid flow control system parameters to improve the performance of an industrial asset. Some embodiments may expedite the optimization of the AFCA system design on a unit-by-unit basis, meaning that each unit will see performance improvement benefits due to the AFCA system that are better than what a “common, fleet-averaged” AFCA system might provide. The speed of the surrogate model expedites the design optimization process so that individual turbine optima can quickly be found within a timescale associated with a commercial sale. Also, the continual improvement of the surrogate model via absorbing the data streams from previously retro-fitted turbines allows for improvement of the performance gains that can be achieved with a custom AFCA system retro-fit. According to some embodiments, new data entering the system may be automatically sensed and used to trigger updates to physics-based models, surrogate models, optimization algorithms, etc. without manual user intervention.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). For example, although some embodiments are focused on specific types of industrial assets, any of the embodiments described herein could be applied to other types of industrial assets including wind turbines, gas turbines, additive manufacturing devices, electrical power grids and storage system, dams, locomotives, airplanes, engines, consumer products, electronic devices, vehicles (including autonomous vehicles, automobiles, trucks, airplanes, drones, submarines), etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with a fluid flow control system for an industrial asset, comprising:
at least one sensor associated with an operating environment measurement of the industrial asset;
a high-fidelity physics-based model that represents operational performance of the industrial asset and the performance's dependency on the operating environment measurement;
a surrogate model creation engine, coupled to the operating environment measurement and results from the high-fidelity physics-based model, to automatically create a surrogate model of the industrial asset; and
an optimization platform to receive the surrogate model and to use the surrogate model along with an optimization algorithm to generate a set of optimized fluid flow control system parameters for the industrial asset.

2. The system of claim 1, wherein the fluid flow control system is associated with at least one of: (i) a subsonic flow environment, (ii) a supersonic flow environment, (iii) a hypersonic flow environment, (iv) a gaseous flow environment, (v) a liquid flow environment, and (vi) a two-phase flow environment.

3. The system of claim 1, wherein the fluid flow control system comprises at least one of: (i) passive flow control components, and (ii) an active flow control actuator array.

4. The system of claim 1, wherein the optimized fluid flow control system parameters are associated with at least one of: (i) physical locations of components of the fluid flow control system, (ii) an orientation of components of the fluid flow control system, (iii) an operational setting of at least one active fluid flow control component, and (iv) a design type of a fluid flow control component.

5. The system of claim 1, wherein the surrogate model creation engine creates the surrogate model using at least one of: (i) a machine learning process, (ii) an artificial intelligence process, (iii) a data regression process, and (iv) a closed-loop control process.

6. The system of claim 1, further comprising:
at least one sensor associated with an operational performance measurement of the industrial asset.

7. The system of claim 6, further comprising:
installing the fluid flow control system on the industrial asset; and
measuring future performance of the industrial asset via the at least one sensor associated with the operational performance measurement.

8. The system of claim 7, further comprising:
using the surrogate model to create optimized fluid flow control system parameters for similar industrial assets.

9. The system of claim 7, wherein the measured future performance is used by the surrogate model creation engine to update the surrogate model.

10. The system of claim 9, wherein measured future performance from a plurality of industrial assets is used by the surrogate model creation engine to update the surrogate model.

11. The system of claim 7, further comprising:
a repository data store to contain the measured future performance of the industrial asset.

12. The system of claim 1, wherein the industrial asset is a wind turbine and the operating environment measurement is associated with at least one of: (i) wind speed, (ii) wind direction, (iii) wind turbulence, (iv) temperature, (v) a proximity to other wind turbines, and (vi) ground topology data.

13. The system of claim 1, wherein at least one of the execution of the high-fidelity physics-based model and the surrogate model creation engine are associated with at least one of: (i) a high-performance computing center, and (ii) a cloud-based computing environment.

14. The system of claim 1, wherein the high-performance physics-based model is associated with a workflow including a plurality of high-fidelity physics-based models.

15. The system of claim 14, wherein the workflow is associated with at least one of:
(i) a component level model, (ii) a module level model, (iii) a system level module, (iv) data that varies in space, (v) data that varies in time, (vi) input parameters, and (vii) post-processing.

16. A computer-implemented method associated with a fluid flow control system for an industrial asset, comprising:
receiving, from at least one sensor, an operating environment measurement of the industrial asset;
receiving results of a high-fidelity physics-based model that represents operational performance of the industrial asset and the performance's dependency on the operating environment measurement;
automatically creating, by a surrogate model creation engine, a surrogate model of the industrial asset based on the operating environment measurement and the results;
receiving, at an optimization platform, the surrogate model; and
using the surrogate model along with an optimization algorithm to generate a set of optimized fluid flow control system parameters for the industrial asset.

17. The method of claim 16, wherein the fluid flow control system is associated with at least one of: (i) a subsonic flow environment, (ii) a supersonic flow environment, (iii) a hypersonic flow environment, (iv) a gaseous flow environment, (v) a liquid flow environment, and (vi) a two-phase flow environment.

18. The method of claim 16, wherein the fluid flow control system comprises at least one of: (i) passive flow control components, and (ii) an active flow control actuator array.

19. A non-transitory, computer-readable medium storing instructions that, when executed by a computer processor, cause the computer processor to perform a method associated with a fluid flow control system for an industrial asset, the method comprising:
receiving, from at least one sensor, an operating environment measurement of the industrial asset;
receiving results of a high-fidelity physics-based model that represents operational performance of the industrial asset and the performance's dependency on the operating environment measurement;
automatically creating, by a surrogate model creation engine, a surrogate model of the industrial asset based on the operating environment measurement and the results;
receiving, at an optimization platform, the surrogate model; and
using the surrogate model along with an optimization algorithm to generate a set of optimized fluid flow control system parameters for the industrial asset.

20. The medium of claim 19, wherein the surrogate model creation engine creates the surrogate model using at least one of: (i) a machine learning process, (ii) an artificial intelligence process, (iii) a data regression process, and (iv) a closed-loop control process.
